(19) United States
(12) Patent Application Publication
(10) Pub. No.: US 2013/0141901 A1
(43) Pub. Date: Jun. 6, 2013

(54) Solar diamond dot dock lite

(71) Applicant: Jeffrey Scott Martzall, Fort Wayne, IN (US)

(72) Inventor: Jeffrey Scott Martzall, Fort Wayne, IN (US)

(21) Appl. No.: 13/373,809

(22) Filed: Dec. 1, 2011

(51) Int. Cl. F21L 4/00; F21V 5/04

(52) U.S. Cl. 362/183; 362/311.01

(57) ABSTRACT

A durable dock light for mounting into a top void on a floating dock. The light has a housing and lens cover that complement the shape of the top dock void. The housing also extends through the dock through hole into the bottom void of the dock. Spring clips are attached to the housing that extends into the bottom void of the dock thus removably mounting the dock light to the dock. The housing and lens cover define a chamber which houses a power storage device, such as a battery, a power collecting device, such as a solar panel, and a light generating device, such as a light emitting diode (LED). The dock light provides a fast solution to lighting a floating dock without costly wiring or electrical cost. The dock light provides lighting at night, making it safer for persons and watercraft operating on or around the dock.

### CROSS REFERENCE TO RELATED APPLICATIONS

Not Applicable

### FEDERALLY SPONSORED RESEARCH OR DEVELOPMENT

Not Applicable

### DESCRIPTION OF THE ATTACHED APPENDIX

Not Applicable

### BACKGROUND OF THE INVENTION

1. Field of Invention

This invention relates generally to the field of marine dock hardware for docks placed over adjacent bodies of water, and more specifically to lighting accessories for floating docks.

2. BACKGROUND OF THE INVENTION

2. Prior Art

Traditionally docks are constructed over water and connect to the shore where persons may walk out over the surface of the water. Docks allow boats to be secured and parked in the water and provide persons the ability to walk to boats without entering the water. Fixed docks are traditionally supported by vertical poles or post so that the horizontal portion of the dock surface is suspended above the water. The vertical supports are driven into the floor of the body of water to affix them in a sturdy manner which can resist the force of waves, boats, persons, freezing water, etc. The horizontal surface of the dock is affixed to the vertical supports and extends between them to make a stable surface above the water. More recently, hollow floating docks have been constructed to lie directly on the surface of the water and affixed in place or to the shore by ropes, chains, cable, guiding poles or other securing manner. Floating docks permit easy construction, removal, flexibility, durability, and other various advantages that may be required or desired for their intended application. Such a dock is described in U.S. Pat. No. 6179,525 B1 to Gruhn, et al., which is incorporated herein by reference.

The Gruhn et al. patent discloses a hollow dock that is made up of separate modular sections coupled together through a series of troughs and sockets. Each dock section has sockets which are voids formed on the top and bottom surface near the edges of the dock section. The top void is a shallow diamond shaped trough with a through hole connecting through to the larger bottom void. The bottom voids fit complementary connecting members that allow users to connect more than one dock section or various accessories together in the manner of modular units. The connecting member present in the bottom void is held in place by a securing device such as a bolt and diamond shaped washer in the top void. This modular floating dock design allows flexibility in the shape, size, and design of the overall dock comprised of various dock sections.

Non-floating docks or traditional docks are often wired for electrical power so that boats may recharge their batteries or run their electrical systems when the boat engine is not running. Additionally, the electrical power on the dock can be used for other purposes such as lights to make the dock visible at night to approaching boats and or persons walking on or using the dock. Floating docks however, are more difficult for electrical power and lighting as they generally reside on the water surface rather than above it. Placing high voltage wiring closer to the water or in the water may be viewed as dangerous and or undesirable thus making electrically powered lighting for floating docks more difficult or impractical. Furthermore, some floating docks are used as swim rafts far from shore and not connected to shore making traditionally wiring methods impracticable or essentially impossible.

There exists a need for a light for floating docks that does not have the disadvantages of the prior art.

### BACKGROUND OF THE INVENTION

### Objects and Advantages

The primary objective of the invention is to provide a durable solar light that fits into the top void of a floating dock.

Another object of the invention is to provide solar light that is easily removable securable in the top void of a floating dock.

Another object of the invention is to provide a solar light which is recessed into the top void of a floating dock to minimize the height at which the solar light protrudes over the top surface of the floating dock thus reducing the chance of persons tripping on the solar light.

Yet another object of the invention is to provide a solar light which does not require accessing the bottom dock void to attach or detach the solar light.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a solar light which fits into the top void of a floating dock; A solar light which is easily removable-securable within said top void, A solar light with specially designed body to recess and protect the unit; A solar light which does not require persons to access the bottom void of the floating dock to attach or detach the unit; A solar light encompassing; a lighting unit encapsulated by a translucent housing; A solar panel to collect energy; A battery to store energy; A light emitting diode to generate light; A circuit to designate how energy is collected and used.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 A perspective view of the top of a solar diamond dot dock lite with visible transparent lens cover, light emitting diode, solar panel, bottom housing, and spring clip.

FIG. 2 a perspective view of the top of a floating dock with visible top and bottom voids.

FIG. 3 an exploded view of a solar diamond dot dock lite with visible transparent lens cover, solar lighting components, housing, and spring clips.

FIG. 4 illustrates a sectional view of a solar diamond dot dock lite with visible internal solar lighting components.

FIG. 5 a perspective view of the bottom of a solar diamond dot dock lite with visible spring clips.

FIG. 6 illustrates a top view of a solar diamond dot dock lite with visible LED, and solar panel.

FIG. 7 Illustrates a front view of a solar diamond dot dock lite.

FIG. 8 Illustrates a side view of a solar diamond dot dock lite.

FIG. 9 Illustrates a bottom view of a solar diamond dot dock lite with visible battery, and spring clips.

FIG. 10 a perspective view of the top of a solar diamond dot dock lite installed into the top void of a floating dock.

FIG. 11 Illustrates a sectional & perspective view of the top of a solar diamond dot dock lite installed into the top void of a floating dock.

FIG. 12 Illustrates a front view of a solar diamond dot dock lite installed into the top void of a floating dock.

FIG. 13 Illustrates bottom perspective view of a solar diamond dot dock lite protruding through into the bottom void area of a floating dock.

FIG. 14 Illustrates bottom perspective view of a solar diamond dot dock lite protruding through into the bottom void area of a floating dock.

FIG. 15 Illustrates a sectional & perspective view of the top of a solar diamond dot dock lite installed into the top void of a floating dock with visible top void, bottom void, and internal solar lighting components.

FIG. 16 Illustrates a sectional front view of a solar diamond dot dock lite with installed into the top void of a floating dock with visible spring clips extending out into the bottom void of the dock.

FIG. 17 Illustrates a perspective & exploded view of a solar diamond dot dock lite and a floating dock with visible top and bottom dock voids.

FIG. 18 Illustrates a perspective view of how multiple solar diamond dot dock lites would be placed into the top voids of a floating dock.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### This is the Detailed Description of the Unit

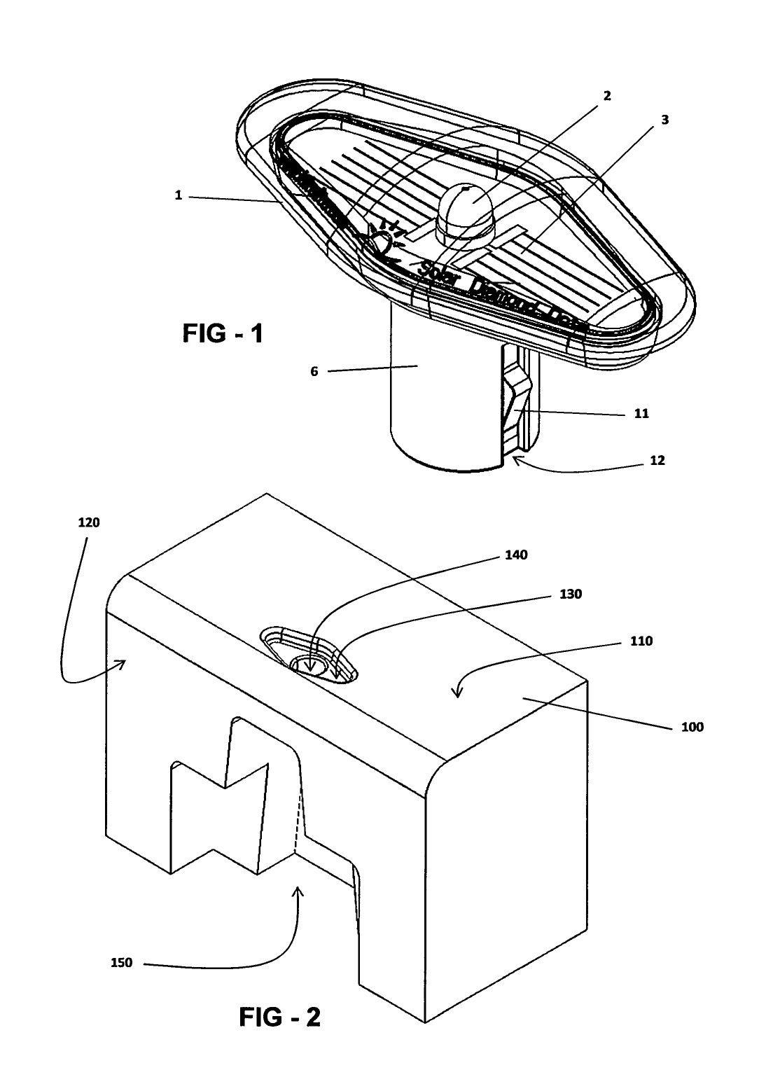

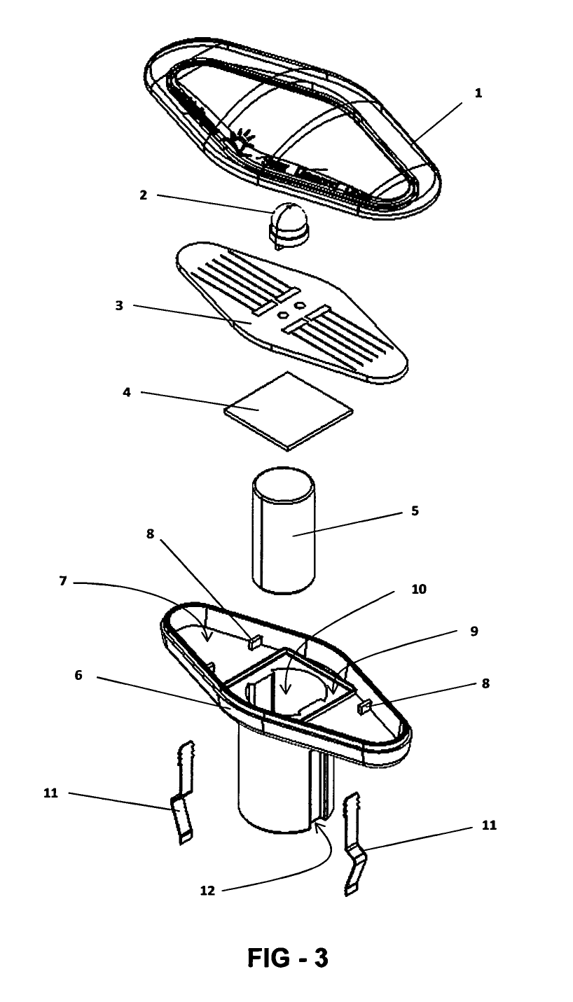

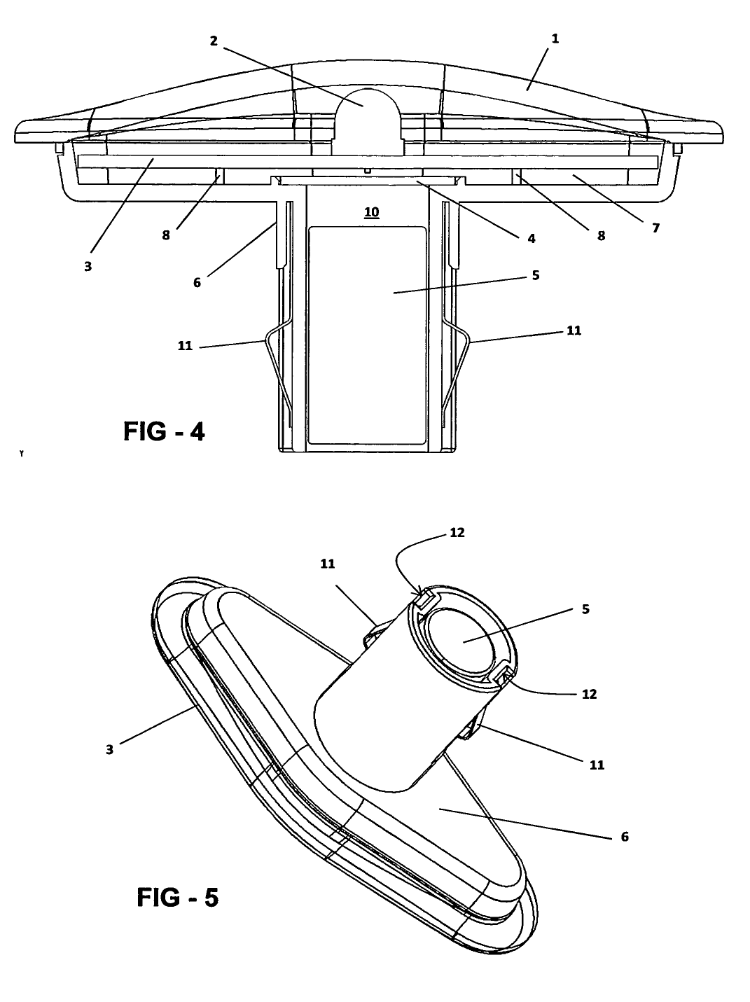

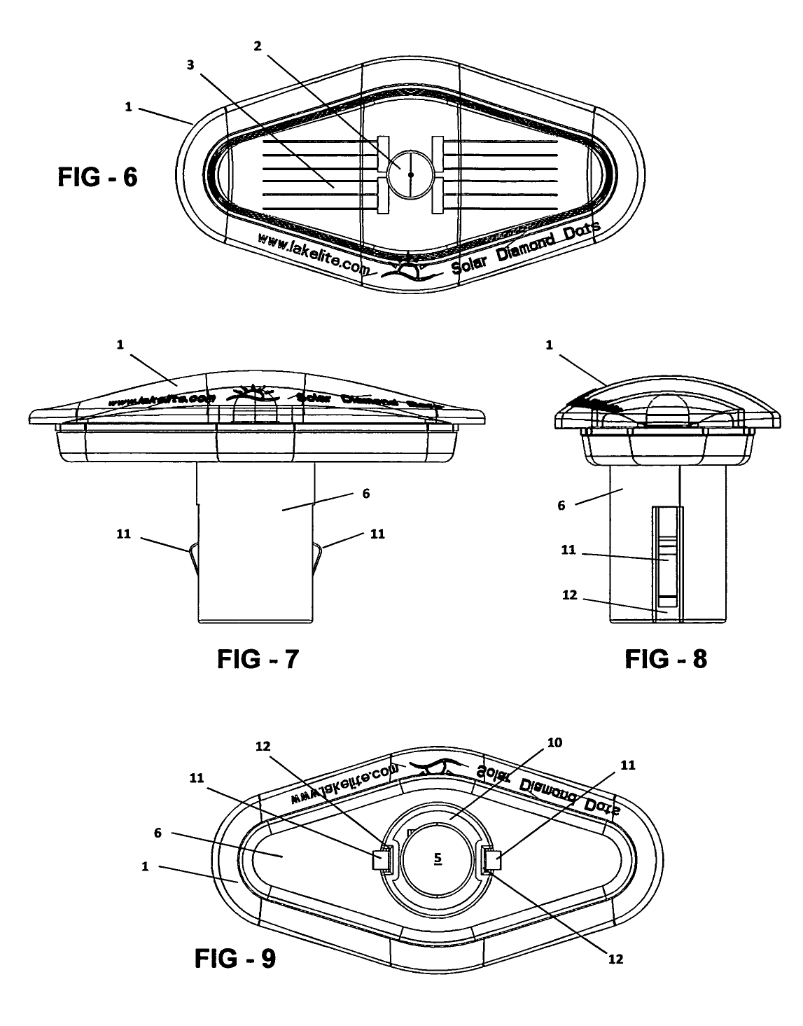

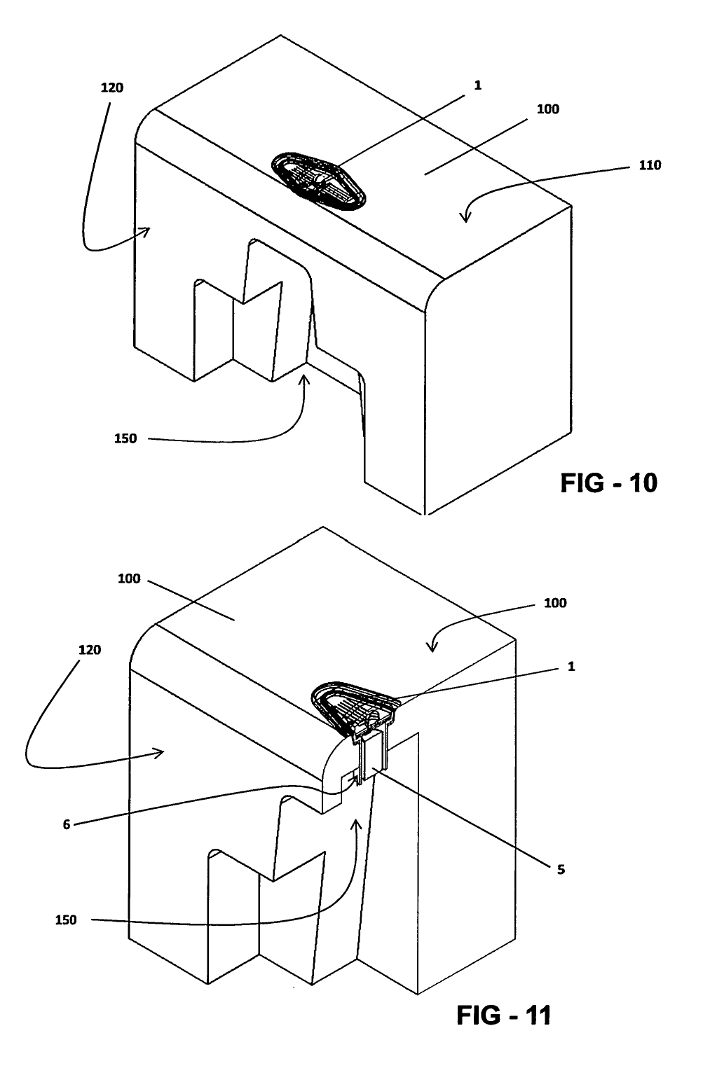

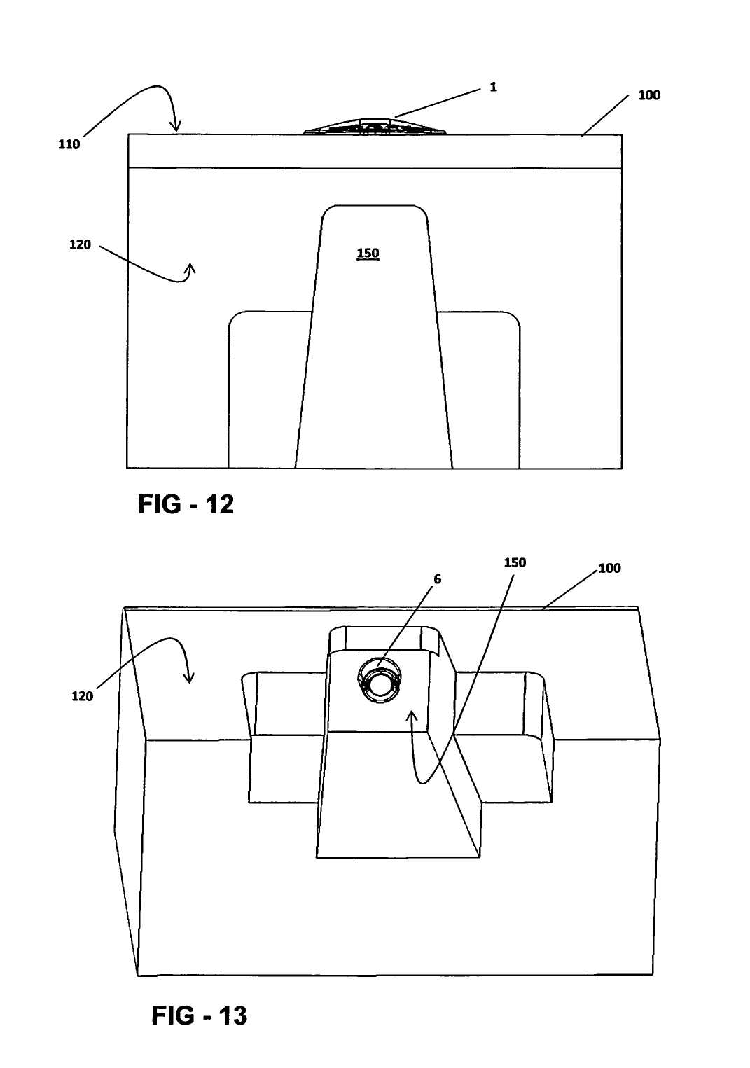

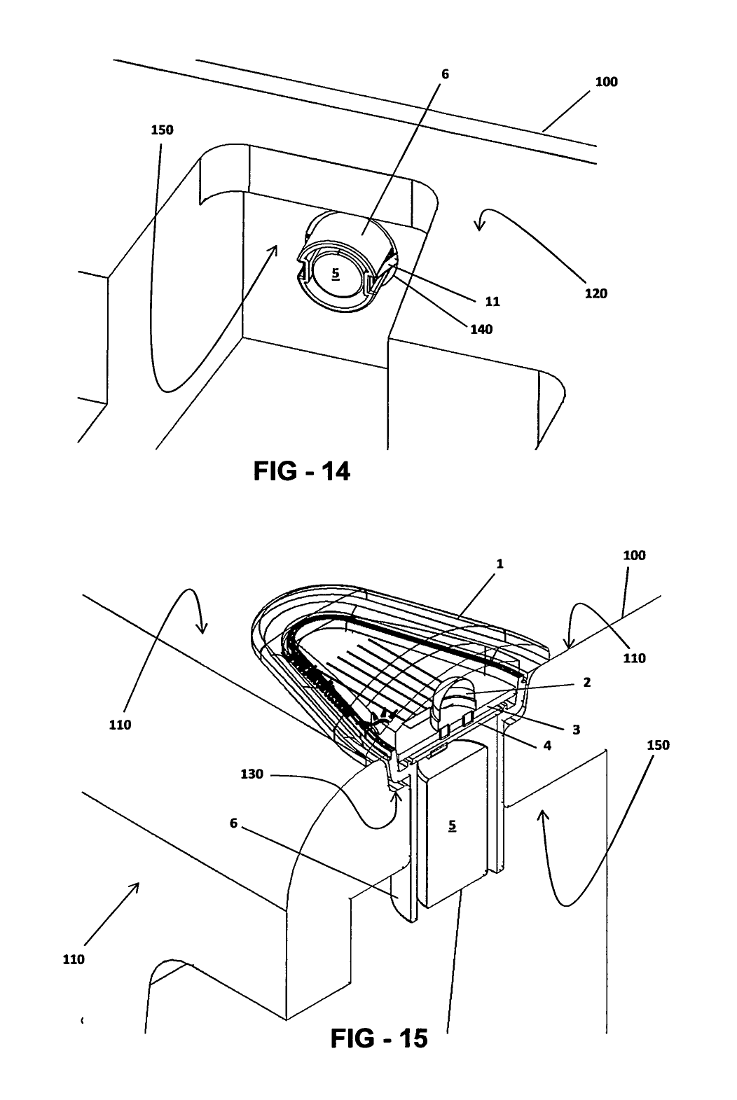

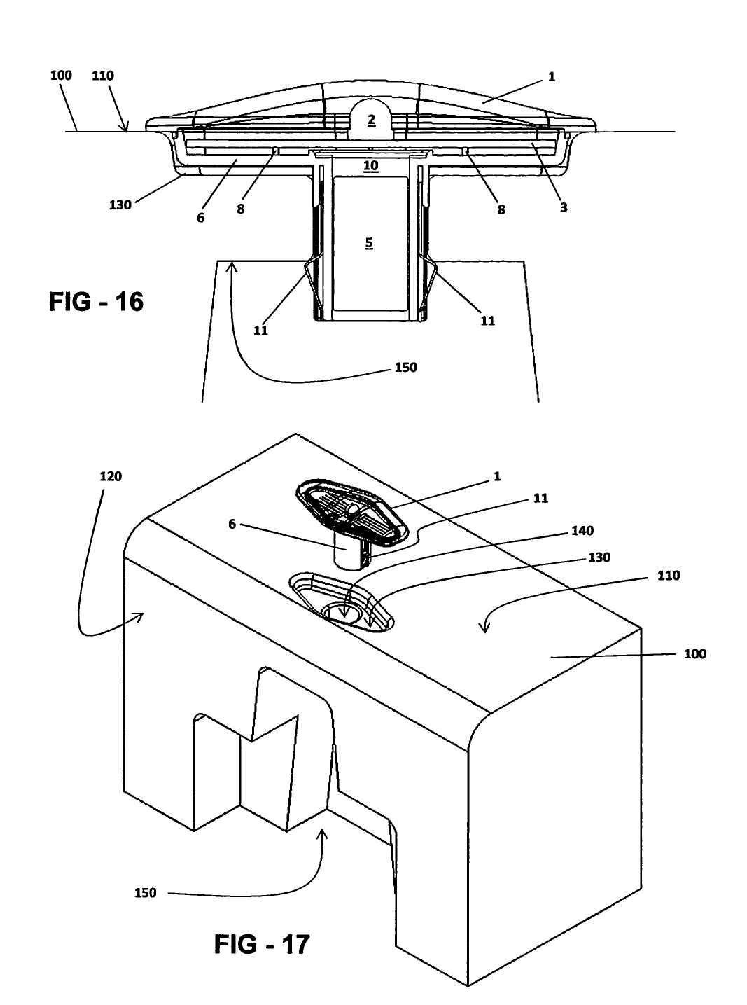

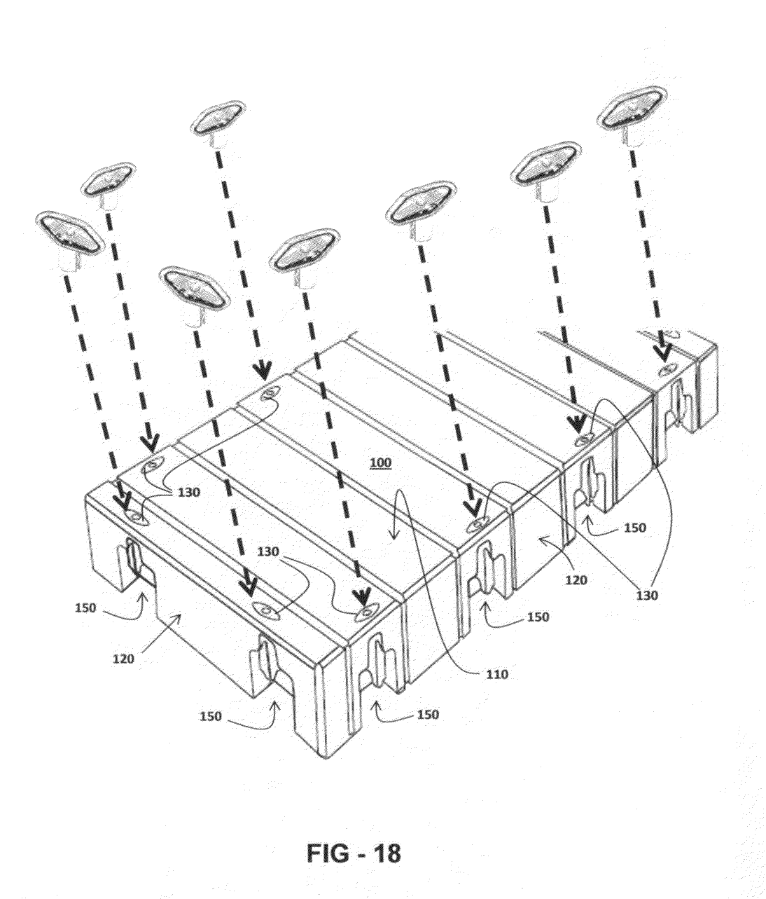

Referring to FIGS. 1 through 18, a molded durable dock light having a housing (6) which is designed to complement the shape of a top dock void (130) which is generally located near the edge of dock (100) or the dock side surface (120). The housing (6) has a battery chamber (10) which extends through the dock through hole (140) into the bottom dock void (150). Spring Clip Grooves (12) are formed into housing (6) to allow attachment of spring clips (11) to Housing (6). Spring clips (11) can be made from various plastics or spring steel to provide a spring like effect. Spring clips grooves (12) are deep enough to allow spring clips (11) to bend inward under force to a point small enough to allow spring clips (11) to fit through dock through hole (140) while affixed to housing (6). Spring Clips (11) are formed in a manor that extends outward from housing (6) so that the natural resting size of spring clips (11) is larger than dock through hole (140). Spring Clips (11) attached to housing (6) extend into the bottom dock void (150) thus securing housing (6) to the dock (100). Spring clips (11) are shaped in a way that constantly provides force against the top portion of bottom dock void (150) yet has the ability to be pulled back through dock through hole (140) when persons needs to remove, replace, or service the preferred embodiment.

The housing (6) is formed with battery chamber (10) wherein a rechargeable battery (5) can be placed. Housing (6) has a recessed solar panel trough (7) to fit a complementary shaped solar panel (3). Raised stand offs (8) are also formed into housing (6) so that solar panel (3) may rest above circuit board (4) that is positioned in circuit board trough (9). Raised stand offs (8) also raise solar panel (3) to a height at which dock surface (110) does not shade solar panel (3) from sunlight. (The circuit board trough (9) is designed to hold circuit board (4) above rechargeable battery (5) when rechargeable battery (5) is placed within the battery chamber (10)

The light emitting diode (2) is placed over the top of solar panel (3) so that light may be projected upward and outward through transparent lens cover (1). Transparent lens cover (1) is designed of thick durable material that easily withstands the weight and force of persons walking or standing on dock surface (110). Transparent lens (1) is affixed to housing (6) preferably by sonic welding or glue. Transparent lens (1) can also be designed to provide various lens effects to help collect more sunlight for solar panel (3). Transparent lens (1) can also be shaped with various lens effects to generate various lighting effects or patterns for light emitting diode (2). Clear potting glue may also be poured into transparent lens cover (1) and housing (6) to seal electrical and internal components from the outside elements.

Solar panel (3) is used for collecting energy from the sun and a storage cell which is rechargeable battery (5) stores energy collected from the solar panel (3). Circuit board (4) controls and designates how power is stored from solar panel (3), and how power is released from rechargeable battery (5) to light emitting diode (2). The circuit board (4) also controls the function of turning the light emitting diode (2) on at sunset and off at sunrise. Circuit board (4) also controls the brightness of light emitting diode (2). Furthermore circuit board (4) protects rechargeable battery (5) from being overcharged by solar panel (3) as well circuit board (4) protects rechargeable battery (5) from being over discharged by light emitting diode (2).

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. a dock light for removable securable insertion into a dock having at least one top void formed therein with a through hole connecting to a bottom void therein where an embodied illumination source can emit and project light outward from at least one or more of said top void and or said bottom void, the said dock light comprising:
(a.) a complementary shaped housing for mounting into said top void of said dock.
(b.) a transparent lens cover extending to the top of said top void in said dock, thus making said transparent lens cover at least level with the top surface of said dock, thus filling said top void in said dock.
(c.) where said top transparent lens can withstand the weight of persons walking or standing on said top transparent lens cover.
(d.) a light source within said housing and said transparent lens cover.

2. a dock light as set forth in claim 1 wherein said dock light has an affixing apparatus to hold said dock light to said dock, comprising:
(a.) grooves formed into the bottom sides of said housing
(b.)spring clips mounted to said housing within said grooves that extend outward from said housing into said bottom void in said dock.

3. a dock light as set forth in claim 1 wherein said housing and said transparent lens cover are designed to cage in and protect said illumination source from the outside elements and forces exerted on said housing and said transparent lens cover

4. a dock light as set forth in claim 1 wherein a solar lighting unit may exist within said housing and said transparent lens cover providing a method for said illumination source emitting and projecting said light outward from at least one or more of said top void and or bottom void in said dock.

5. a dock light as set forth in claim 1 wherein said illumination source is said solar lighting unit, which is self contained, comprising:
(a.) a solar panel for collecting energy from the sun.
(b.) a storage cell to store energy collected from said solar panel
(c.) a light emitting diode to provide said light.
(d.) a circuit board to control power intake from said solar panel and power output to said light emitting diode from said storage cell.
